(19) United States
(12) Patent Application Publication
(10) Pub. No.: US 2005/0115819 A1
(43) Pub. Date: Jun. 2, 2005

(54) System for desalinating and purifying seawater and devices for the system (II type)

(76) Inventor: Ching-Piau Lai, Goushing Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/726,209

(22) Filed: Dec. 1, 2003

(51) Int. Cl. C02F 1/04; B01D 3/00

(52) U.S. Cl. 202/176; 210/175; 210/294; 202/267.1; 203/10; 203/71; 203/DIG. 17; 203/86

(57) ABSTRACT

This invention relates to a system for desalinating and purifying seawater. The system has a separably multilayer configuration and has devices including a top layer, a middle layer, a bottom layer and an outer cooling assembly and four units correspondingly arranged in those devices. The layers all have inner walls made of thermal-conductive and anti-corrosive material. The four units are a heating unit, a desalinating cracking unit, a purifying distillation and a cooling unit.

### FIELD OF THE INVENTION

In general, the present invention relates to a system for desalinating and purifying seawater until the seawater becomes drinkable, and more particularly to a system that has a cyclically desalinating process and a repeatedly purifying process to crack elements in water molecules in the seawater to tiniest molecules and therewith to reform to become drinkable water derived from the oceans. Wherein, viruses, heavy-metallic pollutants and futile elements contained in the seawater are separated and removed to make the fresh water safe without extra treatment, and molecular elements contained in the generated drinkable water easily absorbed and utilized by human body.

### BACKGROUND OF THE INVENTION

Recently, water supplement becomes a worldwide problem. People will face the water shortage in the futures and need an effective solution to resolve the problem of water shortage. Although the earth contains plenty of water, most of the water is seawater (salt water) in the oceans and is not drinkable because the seawater contains too much crude salt containing sodium chloride, non-metallic elements, heavy metals and thousands of unknown elements. Several desalinating methods for the seawater or brine are developed and mainly classified into two types. One type is to use membrane isolation such as reverse-osmosis or electrodialysis. The reverse-osmosis is suitable for desalinating seawater and the electric dialysis is suitable for treating brine containing less quantity of salt. With regard to the reverse-osmosis, electricity consumption and membrane reloading cause an inevitable spending that takes a majority portion in an operational cost of reverse-osmosis. Another type is to distill the seawater, which is a common method used to separate high-volatility materials from non-volatility and low-volatility materials. Wherein, the high-volatility materials are vaporized to obtain the non-volatility and low volatility materials or further the vaporized high-volatility materials are cooled to obtain pure liquids thereof. Distillation-type desalinating methods comprise multi-effect Distillation (MSD), multi-stage flash (MSF), vapor compression (VC) etc. and basically reuse generated heat in an operational system to serve as a heat source of distillation. Therefore, the distillation-type desalinating methods focus on improving thermal-transmission efficiency of equipment in this method.

The foregoing reverse-osmosis method is operated by simple equipment and simple operational procedures and is selectively designed to be small modules or combined with other desalinating systems to become a large-scale desalinating system in a factory. But the reverse-osmosis method has high operational pressure and need more electricity to operate the equipment so that operating cost of the reverse-osmosis method is high. Although the distillation-type desalinating method uses waste heat as a power source, vaporizing and condensing processes must be hold in two separated chambers so that equipment of the distillation-type desalinating method occupies more space than that of the reverse-osmosis method. Additionally, the distillation-type desalinating method is difficult to be operated and controlled. Up to now, the two conventional types of desalinating methods both have high costs and the generated water has less competitive capabilities with naturally obtained fresh water. Moreover, still another desalinating method, so-called membrane-distillation method, which combines advantages of the membrane-osmosis method and the distillation method together. However, the membrane-distillation method has low producing rate (water quantity/per volume unit of equipment) and is easily malfunctioned by blocking porous membranes with crystallization. Therefore, the membrane-distillation method is not widely applied in desalinating systems.

Additionally, still several conventional treatments for tap water are listed and compared in the followings:

1. Boiling method: boiling method can kill bacteria in water but can not remove harmful impurities from water. Moreover, the tap water mostly contains chlorides therein and the chlorides easily become cancer-inducing material, chloroform, after boiling.

2. Filtering method with active carbon: the active carbon can absorbs organic materials and colloids in the water and deodorizes the tap water, but the active carbon has to be changed very often.

3. Ion-exchanging method: ion-exchanging resin is applied to remove metallic ions, such as sodium, magnesium, and calcium ions etc., from the tap water to soften the tap water but can not purify the top water.

4. Ultraviolet (UV) lighting method: the UV lighting method can kill the bacterial but can not remove salt, colloid, particles, and other chemicals from the tap water.

5. Depositing method: the depositing method can not kill bacteria and viruses and can not eliminate heavy metals and toxic chemicals in the tap water.

Moreover, water obtained from desalinated seawater by the conventional desalinating methods still contains some salt and some mineral materials (metallic or non-metallic materials) and is only suitable for washing or irrigation, but is not drinkable. Therefore, the water has to be mixed with fresh water to further boil or filter again to become drinkable. With regard to water obtained from distillation-type desalinating method, the water is almost pure water but still contains some sodium and halogen elements because compounds containing sodium and halogen are vaporized and then reduced into the water after condensation so that the water is harmful to metabolism system of human body if the water is drank without any extra treatment to remove the sodium and halogen compounds. Moreover, some beneficial mineral materials in the water are decomposed after distillation.

According to foregoing desalinating methods, these methods have less concern about the purification. Without purification, the water obtained from desalinating methods still contains small quantity of salts and mineral materials and is not drinkable. For the conventional desalinating methods in present, majority of salt and gesso are removed from the seawater but the generated water obtained from desalinating still contains sodium and halogen elements and is harmful to metabolism system of human body. Additionally, specifically for distillation-type desalinating method, the boilers in the operational system are easily coated with limescale and corroded by corrosive materials in the seawater so that operational system of this method has to be interrupted to clean or change the boilers. Therefore, the boilers have short utility periods and operational cost of the distillation-type desalinating method is increased.

### SUMMARY OF THE INVENTION

The present invent invention provides a system for desalinating and purifying seawater to overcome these drawbacks in the conventional desalinating methods by using a heating unit, a desalinating cracking unit, and a purifying distilling unit cyclically arranged in this system and further by incorporating with a dissociating reducing device proceeding a multi-desalinating process and multiple distilling layers proceeding a repeatedly purifying process to reform the seawater into drinkable water without extra treatment. Moreover, molecular elements in the generated drinkable water can be absorbed and utilized by human body after drinking.

The system for desalinating and purifying seawater in the present invention essentially imitates natural circulation of water on the earth. Rotation of the earth makes the oceans to generate cold and warm currents to convect with each other so that frictions between the currents are generated under the sea. By the frictions, toxic elements and pollutants in the seawater are vaporized, cracked, and then reformed to become other synthetic elements and materials. Additionally, radiation of sunlight penetrates the atmosphere layer and is refracted by different water molecular groups in the atmosphere layer to cause electronic mobility. Therefore, when the sunlight radiates the seawater with highly thermal radiation to vaporize water, vaporized water molecules has multi-friction with the radiation during vaporization. Light elements in the seawater are vaporized to join the atmosphere layer and residual elements in the seawater are cracked by friction and reformed to become tinier water molecular groups. Mostly, elements having high specific gravity and organic pollutants are cracked. For example, organic pollutants such as bacteria and odors can be decomposed by oxidizing reaction caused from lighting titanium dioxide by UV light. Wherein, the titanium dioxide generates a pair of electron and electron hole and then generates free hydroxide radical (OH⁻) having high oxidizing capability to decomposed the bacteria and odor to purify the seawater. The vaporized water molecules are cooled by air and condensed to become raindrops falling to the ground. Some raindrops falling into rivers dissolve impure elements on the ground and return to the ocean. The raindrops in the ocean are recombined with other elements in the ocean to become the seawater. Some raindrops are stored on the ground to perform lakes or permeate the ground to become groundwater. The raindrops are filtered by multiple geology strata to become pure groundwater (cleanest original water) that has different quality and quantity with water on the ground. Principles and techniques in the present invention are essentially based on the natural circulation of water and imitate vaporization caused by heat of the earth core. Additionally, a desalinating cracking unit in the system of the present invention has a dissociating reducing device, which has functions similar to those of the earth geologic strata and ground, attached to a bottom of the desalinating cracking unit.

A first technical character of the present invention is that the system comprises multiple separable devices including a top layer, a middle layer, a bottom layer, and an outer cooling assembly, and four units correspondingly arranged within the layers and the outer cooling assembly to allow the system to be constructed and cleaned easily. The devices are made of ceramics or other materials having excellent thermal-conducting and anti-corrosive capabilities to eliminate coating of limescale and corrosion to the devices so as to avoid malfunction of the devices. Additionally, the heating unit has an impurity depositing area with an impurity outlet attached to a bottom of the heating unit to collect and discard impurity and non-volatile materials via the impurity outlet. Therefore, the system enables to be operated fluently.

A second technical character of the present invention is that the heating unit is modified to comprise a heater to heat the seawater inside the system to cause currents flowing in the system to accelerate the boiling of the seawater.

A third technical character of the present invention is that the desalinating cracking unit has at least one dissociating reducing device having functions similar as those of the geologic strata and the ground. When the high temperature steam arises to flush to the dissociating reducing device to generate frictional effects, by that the dissociating reducing device generate vibration to crack and reform the water molecules in the steam. Heavy metal and heavy water are separated from light elements in the water molecules and then conducted back to a pen-shaped dividing plate to be vaporized again to achieve a cyclically desalinating cracking process. Then, light and clean steam is conducted to the purifying distilling unit in the top layer.

A fourth technical character of the present invention is that the purifying distilling unit comprises a distilling tower. The distilling tower is composed of multiple distilling layers and each distilling layer has multiple ventilating holes defined therein. Each distilling layer is dome-shaped with a top convex face and a bottom concave face to conduct steam unable to pass through the distilling tower back the desalinating cracking unit. Residual space inside the distilling layer contains the. By impact effects of the steam induced by the ventilating holes in each distilling layer within the distilling tower, the steam generated by the dissociating reducing device in the desalinating cracking unit is sieved again to allow only the tiniest water molecules in the steam passing through distilling tower. Then, the tiniest water molecules enter the cooling unit to be condensed. Residual steam unable to pass through the distilling tower is conducted back to the desalinating cracking unit to be heated, cracked and reformed again to achieve a repeatedly purifying circulation.

### BRIEF DESCRIPTION OF THE DRAWINGS

FIG. 1 is a schematically flowchart of a system for desalinating and purifying seawater in accordance with the present invention;

FIG. 2 is a schematically flowchart of devices in a cyclical process composed of a desalinating cracking unit and a purifying distilling unit in FIG. 1; and

FIG. 3 is a cross-sectional side plane view of devices applied to the system in the present invention.

### DETAILED DESCRIPTION OF THE PREFERRED EMBODIMENT

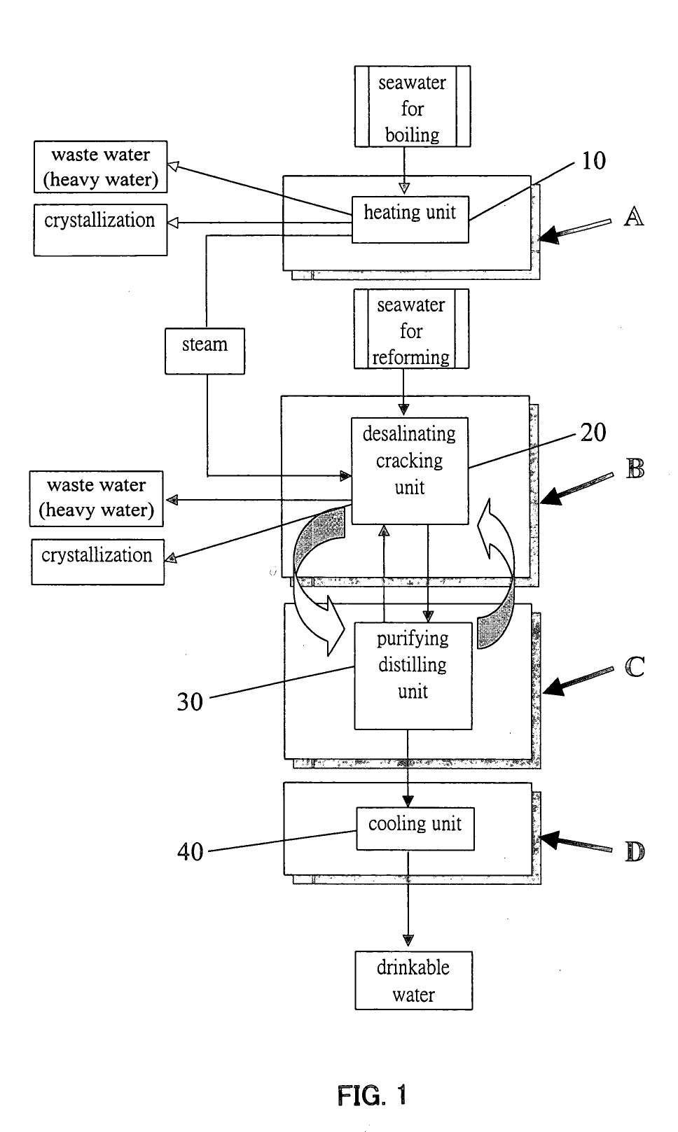

A system for desalinating and purifying seawater in the present invention is shown schematically in FIG. 1 in a generalized fashion. The system is designed for a separably multilayer configuration and comprises multiple devices containing a bottom layer A, a middle layer B, a top layer C, and an outer cooling assembly D and four units correspondingly arranged in the multiple devices. The bottom layer A contains a heating unit 10. The middle layer B contains a desalinating cracking unit 20. The top layer B contains a purifying distilling unit 30. The outer cooling assembly D contains a cooling unit 40. Particularly, the bottom layer and the middle layer are two individually hermetical layers. Initially, the seawater or fresh water for boiling is conducted into the heating unit 10 in the bottom layer A and another part of the seawater for manufacturing drinkable water is conducted into desalinating cracking unit in the middle layer B. In the heating unit 10, the seawater is heated to boil to generate steam and then the steam is introduced into the desalinating cracking unit 20 in the middle layer B to heat the another part of the seawater in the desalinating cracking unit 20. Water molecules in the steam are desalinated and cracked in the desalinating cracking unit 20 to generate cracked steam having finer quality. The cracked steam arises to the purifying distilling unit 30 in the top layer C. The desalinating cracking unit 20 and the purifying distilling unit 30 communicate with each other to achieve a cyclically desalinating and repeatedly purifying process (as shown by arrows in FIG. 1). Impurities and elements unable to be cracked in the water molecules are deposited back to the desalinating cracking unit 20 to become waste water (heavy water) and crystallization residuum. In the purifying distilling unit 30, the tiniest steam and tiny elements in the water molecules pass through the purifying distilling unit 30 and enter the cooling unit 40 in the outer cooing assembly D. Additionally, residually high temperature steam in the purifying distilling unit 30 is conducted back to the desalinating cracking unit 20 in the middle layer B to be condensed to finally achieve drinkable water.

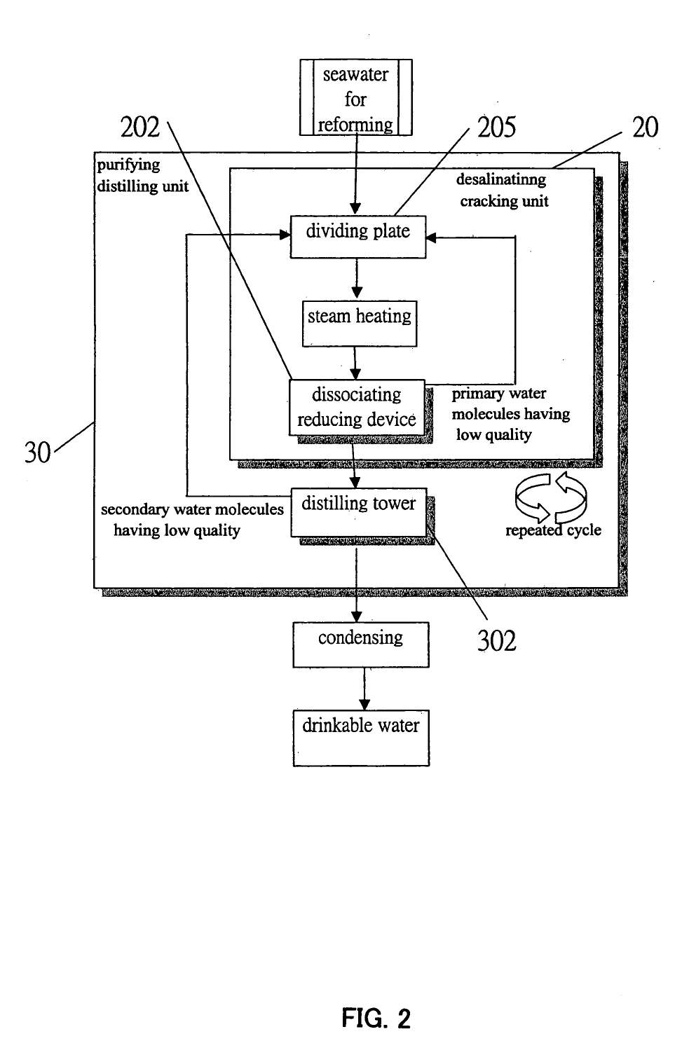

FIG. 2 is a schematically flowchart of the devices in a cylindrical process composed of the desalinating cracking unit and the purifying distilling unit. In FIG. 2, the main feature in the present invention is that the seawater for generating drinkable water pours into the desalinating unit 20 and heat by steam from the heating unit 10 on a dividing plate 205 to generate the steam. The steam is introduced into a dissociating reducing device 202 and flush to the device 202 at high speed to make the water molecules in the steam crack and reform. Heavy metallic element and heavy water are separated from light elements in the water molecules. Impurities of water molecules unable to boil and water molecules unable to crack both compose the waste water (heavy water) and crystallized residuum and are conducted back to the dividing plate 205 to be vaporized again. This is a cyclic and repeatedly desalinating and cracking process. Water molecules reformed in the desalinating unit 20 are introduced upward into a distilling tower 32 to be purified and distilled. The distilling 302 sieves the water molecules to allow only tiniest water molecules passing through to enter the cooling unit 40 and to be condensed to finally achieve drinkable water. Residual water molecules are condensed and conducted back to the dividing plate 205 to be reheated, desalinated, and cracked. This is a cyclic and repeatedly purifying process.

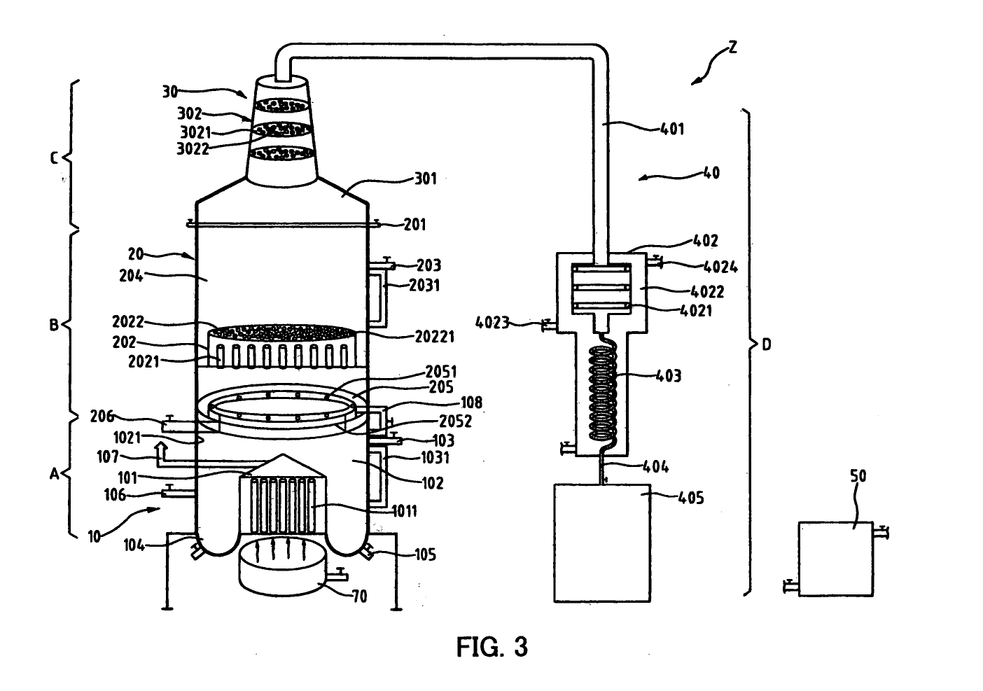

FIG. 3 is a schematically cross-sectional view of devices in accordance with the present invention. The devices in the system for desalinating and purifying seawater, in preferred embodiments, are designed into separably multiple layers comprising a bottom layer A, a middle layer B, a top layer C, and an outer cooling assembly D. The bottom layer A contains the heating unit 10, the middle layer B contains the desalinating cracking 20, the top layer contains the purifying unit 30, and the outer cooling assembly D contains the cooling unit 40. The bottom layer A and the middle layer B are hermetical. The heating unit 10 in the bottom layer A has a heater 101 inside, a heating chamber 102, a water inlet 103, a water-level monitoring panel 1031, an impurity depositing areas 104 around the heater 101, impurity outlet 105, waste water outlet 106, and a steam pipe 108. The heater 101 connects to a base of the heating unit 10 to directly receive heat from an outer heating device 70 and is composed of multiple stainless steel tubes arranged in a circle and a cone-shaped cap mounted on the stainless steel tubes. A gas outlet 107 is attached to one side of the heater 101 to drain overmuch gas out from the heating unit 10. The heating chamber 102 has an inner wall made of thermal-conductive and anti-corrosive material to serve as a thermal-exchanging wall 1021 to absorb heat and to evenly heat the seawater to cause reflux and to accelerate the boiling of the seawater to generate the steam in a mass. The steam is introduced into the desalinating cracking unit 20 via the steam pipe 108. The water inlet 103 conducts the seawater into the heating unit 10 or selectively connects with a cleaning device (not shown) to clean the system. The impurity depositing area 104 collects the impurities and the crystallized residuum and then the impurity outlet 105 drains them out of the heating unit 10. The waste water outlet 106 drains the heavy water and waste water out of the heating unit 10. Preferably, the water inlet 103 in the heating unit 10 is controlled by an automatically controlling system to control quantity of the seawater and to automatically supply the seawater into the heating chamber 102.

The desalinating cracking unit 20 in the middle layer has the dividing plate 205 with multiple steam holes 2051 defined at a bottom of the desalinating cracking unit 20. The steam in the heating unit 10 injects to the desalinating cracking unit 20 via the steam holes 2051. A depositing groove 2052 is defined around the dividing plate 205 for storing the impurities and a waste water outlet 206 communicate to the depositing groove 2052 to drain out the impurities. The dissociating reducing device 202 is secured in the middle layer B above the dividing plate 205 and residual space in the middle layer B is defined as a steam chamber 204. The dissociating reducing device 202 is a round-shape constructed in a singular layer clamped by a top plate and a bottom plate both preferably made of stainless steel. Selectively, the dissociating reducing device 202 is designed for a boiler. The steam chamber 204 has an inner wall made of thermal-conductive and anti-corrosive material. A water inlet 203 with a water-level monitoring panel 2031 is attached to one side of the steam chamber 204. The water inlet 203 conducts the seawater into the desalinating cracking unit 20 and the waste water outlet 206 drain the waste water (heavy water) and the crystallized residuum out of the system. Heating steam conducted via the steam pipe 108 heats the seawater in the desalinating cracking unit 20 to generate steam. The generated steam flushes to the dissociating reducing device 202 at high speed to cause frictional efficiency. By the frictional efficiency, the dissociating reducing device 202 vibrate to crack and reform water molecules in the steam. Heavy metallic element and heavy water are separated from light elements in the water molecules. Impurities of water molecules unable to boil and water molecules unable to crack both compose the waste water (heavy water) and crystallized residuum and are conducted back to the dividing plate 205 to be vaporized again. This is a cyclic and repeatedly desalinating and cracking process. Water molecules reformed in the desalinating unit 20 are cleaner and lighter and introduced upward into a distilling tower 302 to be purified and distilled.

The purifying distilling unit 30 in the top layer C has a distilling tower 302 constructed at a top of the purifying distilling unit 30. The distilling tower 302 is composed of multiple distilling layers 3021 and each distilling layer 3021 has multiple ventilating holes 3022 defined therein. Each distilling layer 3021 is a dome-shape has a top convex surface and a bottom concave surface to guide the steam, which is unable to pass through the purifying distilling unit 30, back to the desalinating cracking unit 20 in the middle layer B. Residual space in the top layer C is defined as a steam chamber 301. The high temperature steam flushes to the multiple distilling layers 3021 in the distilling tower 302 and the ventilating holes 3022 in the distilling layer 3021 to cause physically guiding effect. Thereby, water molecules in the steam from the desalinating cracking unit 20 are sieved to allow tiniest water molecules and tiny elements in the water molecules passing through the purifying distilling unit 30 to reach the outer cooling assembly D. Residual water molecules are condensed and conducted back to the dividing plate 205 to be reheated, desalinated, and cracked. This is a cyclic and repeatedly purifying process.

The layers with three corresponding units are piled into a cylinder. The dividing plate 205 in the middle layer B and the bottom layer A are hermetically combined together. A top of the middle layer B and the top layer C are hermetically combined by means of engaging rings 201.

The cooling unit 40 in the outer cooling assembly D has gas pipe 401, a condensing chamber 402, and a helically heat-exchanging tube 403. The gas pipe 401 introduces the tiniest water molecules in the steam from the purifying process into the condensing chamber 402 having multiple cooling devices 4021. A cold water chamber 4022 is constructed around the condensing chamber 402. An outlet 4024 is attached to an upper portion of the cold chamber 4022 and an inlet 4023 is attached a lower portion of the cold chamber 4022. Cold water or iced water is conducted into the cold water chamber 4022 via the inlet 4023 to condense the steam in the multiple cooling devices 4021 to generate water. When the cold water or the iced water gets warm, the warm water is drained out from the cold water chamber 4022 via the outlet 4024. The water in the cooling device 4021 is introduced into the helically heat-exchanging tube 403 below the condensing chamber 402 to be quickly cooled down and then the water drops into a container 405 via a connecting tube 404.

When desalinates and purifies, the seawater is selectively pushed into a pre-treating filtering device 50 by pumps to remove large particles from the seawater. Then, the filtered seawater is conducted to the heating unit 10 in the bottom layer A via the water inlet 103 to enter the heating chamber 102. Meanwhile, another part of the filtered seawater is conducted to the desalinating cracking unit 20 in the middle layer B via the water inlet 203. (the generated water is in an amount of 90 wt % of the seawater) Flammable gas, heavy oil, electrothermal energy, solar energy or steam from boilers is provided to heat the bottom of the heating unit 10. The heater 101 receives the heat from the bottom of the heating unit 10 and transmits the heat to the seawater by the stainless steel tubes that are arranged in a cycle to increase more heating areas. The seawater is heated and then generates currents to accelerate the heating. Additionally, the thermal exchanging wall 1021 made of thermal-conductive and anti-corrosive material evenly transmits heat to the seawater when the seawater reaches a certain temperature. The seawater boils in the heating unit 10 and generates a lot of steam. Then, the steam is introduced into the dividing plate 205 via the steam pipe 108 to heat cold seawater in the desalinating cracking unit 20. Because the dividing plate 205 is made of thermal-conductive and anti-corrosive material and is shaped into an annular concave disk with the multiple steam holes 2051, the steam injects into the desalinating cracking unit 20 to heat the cold seawater to boil and generate steam. The generated steam flushes upward to the dissociating reducing device 202 to cause high temperature impact and high speed friction. The dissociating reducing device 202 then vibrates to crack and reform the water molecules. Toxic elements, heavy metallic elements, salts, calcium carbonate in the water are separated from light water molecule containing elements and mineral elements. Since the seawater impact with the dissociating reducing device 202 to provide thermal energy, hydrogen and oxygen elements in the water molecules enable to be burned to accelerate vaporization of light elements in the water molecules and other trace elements dialyzed from the seawater. The heavy elements are recombined with the heavy water and sunk to the dividing plate 205 to boil again. The light elements with the water molecules arise to the desalinating cracking unit 20 and repeat boiling and cracking processes until non-boiling and non-cracking impurities generate. The impurities are deposited and collected in the impurity depositing area 2052 in the dividing plate 205 and then drained out via the waste water outlet 206. The impurities enable be properly treated and reused. Light water molecules desalinated and cracked by the dissociating reducing device 202 arise to the steam chamber 301 of the purifying distilling unit 30 in the top layer C. The steam fills the three distilling layers 3021 in the distilling tower 302 secured at the top of the purifying distilling unit 30. The steam flushes and impacts the multiple ventilating holes 3022 to cause physically inducing effect to sieve the steam after cracking and reforming in the desalinating cracking unit 20. Light water molecules in the steam able to pass through the distilling tower 302 are introduced into the cooling unit 40 and then are condensed. Residual water molecules unable to pass through the distilling tower 302 are conducted back to the dividing plate 205 in the desalinating cracking unit 20 since the distilling layers 3021 has an dome-shape. The residual water molecules on the dividing plate 205 are in form of water and are heated, cracked, and reformed again to flow in the repeatedly purifying process. Lastly, the sieved water molecules passing through the distilling tower 302 are introduced into the cooling unit 40 in the outer cooling assembly D via gas pipe 401. In the cooling unit 40, the sieved water molecules in the steam are introduced into the cooling device 4021 in the cooling chamber 402. The cooling device 4021 is surrounded by the cold water chamber 4022 with the inlet 4023 and the outlet 4024. When the cold water or the iced water fills in the cold water chamber 4022, heat of the steam is transferred to the cold water or the iced water so that the steam is condensed to become warm water. Lastly, the warm water is drained to the helically heat exchanging tube 403 to be quickly cool down in the helically heat-exchanging tube 403. The cool water is dropped via the connecting tube 404 and collected in the container 405.

Additionally, the water inlet 103 selectively connects with the pre-treating filtering device 50 to remove the large particles from the seawater. Then, the filtered seawater in conducted to the heating chamber 102 in the heating unit 10 so as to reduce impurities in the system and accelerate the processes in the system.

When the devices Z are cleaned, the water inlet 103 selectively connects with a detergent supplier input detergents into the system, wherein the detergent is preferred to be non-toxic citric acid. The waste water outlet 106 and the impurity outlet 105 enable to respectively drain residual heavy water and impurities out the system. Because the inner walls of the heating chamber 102 and the steam chamber 204 are made of stainless steel, devices in the system are not easily coated with limescale and not be corroded by the seawater so that frequency of cleaning the system is reduced.

Main feature of the present invention is to use a cyclically and repeatedly process composed of the desalinating cracking unit 20 and the purifying distilling unit 30, multiple cracking processes in the dissociating reducing device 202, and repeatedly purifying processes in the distilling tower 302 to crack and reform the water molecules in the steam to generate drinkable water containing trace elements that is beneficial for human body.

Although particular and specific embodiments of the invention have been disclosed in some detail, numerous modifications will occurs to those having skill in the art, which modifications hold true to the spirit of this invention. Such modifications are deemed to be within the scope of the following claims.

1. A system for desalinating and purifying seawater to become drinkable water and devices for the system, the system and the devices comprising:
a bottom layer having
a heating unit with a base comprising a heating chamber with a bottom and an inner wall made of thermal-conductive and anti-corrosive material, a heater accommodated inside the heating chamber, an impurity depositing area defined in the bottom of the heating chamber, an impurity outlet communicating with the impurity depositing area inside the heating chamber, a water inlet communicating with the heating chamber, an waste water outlet communicating with the heating chamber above the impurity depositing area, and a steam pipe attached to the heating chamber, wherein the heater is connected to the base of the heating unit and adapted to receive thermal energy from an outside heating device;
a middle layer having
a desalinating cracking unit mounted over the heating unit to generate steam and comprising a dividing plate made of thermal-conductive and anti-corrosive material and attached to a bottom of the middle layer, a dissociating reducing device secured over the dividing plate, an impurity depositing area on the dividing plate, a waste water outlet communicating to the impurity depositing area, a steam chamber surrounding the dividing plate and the dissociating reducing device, and a water inlet with a water-level monitoring panel attached to the steam chamber;
a top layer having
a purifying distilling unit communicated with the desalinating cracking unit and comprising a distilling tower with multiple distilling layers, multiple ventilating holes defined in each of the multiple distilling layers, and a steam chamber constructed below the distilling tower; and
an outer cooling assembly connected to the top layer and having
a cooling unit comprising a condensing chamber, a gas pipe connected between the distilling tower and the condensing chamber, a helically heat-exchanging tube connected below to the condensing chamber;
wherein, the bottom layer, the middle layer, and the top layer are separable;
wherein, the desalinating cracking unit and the purifying distilling unit communicate with each other to achieve a cyclically purifying process so that the seawater is repeatedly desalinated, purified and reformed by cracking processes in the dissociating device and by repeatedly purifying processes in the distilling tower to generate the drinkable water.

2. The system and the devices as claimed in claim 1, wherein the heater in the heating unit comprises multiple stainless steel tubes evenly arranged in a circle and a cone-shaped cap mounted on the multiple stainless steel tubes.

3. The system and the devices as claimed in claim 1, wherein at least one gas outlet respectively attached to the heater in the heating unit.

4. The system and the devices as claimed in claim 1, wherein the water inlet in the heating unit connects to a pre-treating filtering device.

5. The system and the devices as claimed in claim 1, wherein the water inlet in the heating unit is extending to the sea to conduct the seawater to the heating chamber.

6. The system and the devices as claimed in claim 1, wherein the water inlet in the heating unit connects to a detergent supplier to input detergent to clean the system.

7. The system and the devices as claimed in claim 6, wherein the detergent is nontoxic citric acid.

8. The system and the devices as claimed in claim 4, wherein pre-treating filtering device filter the seawater to remove particles from the seawater,

9. The system and the devices as claimed in claim 1, wherein the water inlet in the desalinating cracking unit connects to a pre-treating filtering device.

10. The system and the devices as claimed in claim 4, wherein the water inlet in the desalinating cracking unit is extending to the sea to conduct the seawater to the heating chamber.

11. The system and the devices as claimed in claim 1, wherein the water inlet in the desalinating cracking unit connects to a detergent supplier to input detergent to clean the system.

12. The system and the devices as claimed in claim 1, wherein the water inlet in the heating unit is controlled by an automatically controlling system to control quantity of the seawater and to automatically supply the seawater.

13. The system and the devices as claimed in claim 1, wherein the dividing plate is shaped into an annular concave disk.

14. The system and the devices as claimed in claim 1, wherein the dividing plate has the multiple steam holes defined through the dividing plate.

15. The system and the devices as claimed in claim 1, wherein the dissociating reducing device in the desalinating cracking unit is flushed by the steam to vibrate to crack elements within water molecules of the steam.

16. The system and the devices as claimed in claim 1, wherein the dissociating reducing device in the desalinating cracking unit is made of stainless steel.

17. The system and the devices as claimed in claim 1, wherein the dissociating reducing device in the desalinating cracking unit is round-shaped.

18. The system and the devices as claimed in claim 1, wherein the dissociating reducing device in the desalinating cracking unit is made for a boiler.

19. The system and the devices as claimed in claim 1, wherein the dissociating reducing device in the desalinating cracking unit is constructed in a singular layer.

20. The system and the devices as claimed in claim 1, wherein the dissociating reducing device in the desalinating cracking unit has multiple manifold pipes.

21. The system and the devices as claimed in claim 1, wherein the dissociating reducing device in the desalinating cracking unit is clamped by a top plate and a bottom plate, both the top plate and the bottom plate are made of stainless steel.

22. The system and the devices as claimed in claim 21, wherein multiple round holes are respectively defined on the bottom plate and the top plate.

23. The system and the devices as claimed in claim 1, wherein each of the multiple distilling layers in the distilling tower is made of stainless steel.

24. The system and the devices as claimed in claim 1, wherein each of the multiple distilling layers in the distilling tower is dome-shaped.

25. The system and the devices as claimed in claim 1, wherein the condensing chamber in the cooling unit has at least one condensing device accommodated inside the condensing chamber.

26. The system and the devices as claimed in claim 25, wherein a cold water chamber surrounds the at least one condensing device.

27. The system and the devices as claimed in claim 26, wherein the cold water chamber has a top and a water inlet attaches to the cold water chamber near the top.

28. The system and the devices as claimed in claim 26, wherein the cold water chamber has a bottom and a water outlet attaches to the cold water chamber near the bottom.

29. The system and the devices as claimed in claim 1, wherein the top layer and the middle layer are hermetically engaged by means of engaging rings.

30. The system and the devices as claimed in claim 26, wherein the bottom layer and the middle layer are hermetically by clamping the dividing plate therebetween.
